(19) United States
(12) Patent Application Publication
(10) Pub. No.: US 2026/0050838 A1
(43) Pub. Date: Feb. 19, 2026

(54) ONE-SHOT, AUTOMATED, MULTI-SEASONAL AUTOREGRESSIVE TABULAR-FORECASTER

(71) Applicant: Oracle International Corporation, Redwood Shores, CA (US)

(72) Inventors: Mobina Mahdavi, Vancouver (CA); Ritesh Ahuja, Los Angeles, CA (US); Hesam Fathi Moghadam, Sunnyvale, CA (US); Rhicheek Patra, Zurich (CH); Hassan Chafi, Zurich (CH)

(21) Appl. No.: 18/806,580

(22) Filed: Aug. 15, 2024

(51) Int. Cl. G06N 20/20

(52) U.S. Cl. CPC G06N 20/20

(57) ABSTRACT

For machine learning of timeseries forecasting, here is discovery of multiple seasonalities by autoregression. A multivariate timeseries contains a variable that has a first seasonality that has a first period and a second seasonality that has a second period that is longer than the first period. Many local maxima of an autocorrelation of the variable in the timeseries are selected. For each local maximum as a distinct lag, a candidate feature that lags the variable based on the distinct lag is inserted into the timeseries. Feature selection selects a minimal subset of the candidate features. Based on the minimal subset of features, a feature vector that represents a point in the timeseries is generated. From the feature vector, a future value for the variable is predicted.

### FIELD OF THE INVENTION

The present invention relates to machine learning for timeseries forecasting. Multiple seasonalities are discovered by autoregression.

### BACKGROUND

Recent proliferation of devices and sensors has led to collection of vast amounts of correlated time-ordered data at high frequency within interconnected systems. A larger system may contain interconnected components that influence each other and affect each other's future telemetry values. A system can be represented as timeseries data that contains correlations that may improve accuracy of a forecasting machine learning model. Timeseries data is lengthy and contains complex characteristics (such as periodic patterns) that may be difficult for a forecasting model to detect and apply.

A timeseries may be univariate or multivariate, which are different amounts of variables. An exogenous variable has a value that is determined by factors outside the system being observed. In other words, an exogenous variable is an influencing factor that originates from somewhere else. An exogenous regressor is an independent variable (a.k.a. explanatory variable) that is not correlated with the error term of the forecasting model. The error term represents all the unexplained (i.e. unlearned) factors affecting the dependent variable that is being predicted.

The problem is to design a forecasting algorithm that can make accurate forecasts on data that is lengthy, has complex characteristics that include temporal patterns, and which are generated within a loosely-coupled system comprised of interconnected components (i.e., exogenous variables) that affect each other's future behavior. On such data, state of the art statistical modelling formats are inaccurate (i.e. lossy) in their ability to capture complex autoregressive correlations that may, for example, contain multiple distinct temporal patterns that can, for example, sometimes cancel each other out and other times combine to magnify telemetry values.

Another issue with machine learning forecasters is the problem of out-of-bound predictions in a trend of a timeseries. In generic regression problems, training and testing datasets are presumed to have a same statistical distribution. However in forecasting problems, for a timeseries that exhibits an upward or downward trend, the training and test dataset usually have different statistical distributions (e.g. mean).

The primary variable is the variable of interest whose future values need forecasting. A primary variable's historical data is the main source for a forecast, but it may be influenced by other variables within the system. Exogenous variables in a statistical model are external factors that are not influenced by the model and can affect the primary variable. To make accurate predictions, a model should exploit correlations between the primary variable and other variables that are together part of a larger system. However, industry approaches assume that, for exogenous variables, future values are available, and hence may be easily utilized as an input feature for forecasting the primary variable. However, some (e.g. future) values of an exogenous variable often are unavailable, which limits accuracy of the state of the art.

### BRIEF DESCRIPTION OF THE DRAWINGS

In the drawings:

FIG. 1 is a block diagram that depicts an example computer that uses autoregression to discover multiple seasonalities in a multivariate timeseries from which a trained regression model predicts a future value for a dependent variable;

FIG. 2 is a flow diagram that depicts an example computer process that uses autoregression to discover multiple seasonalities in a multivariate timeseries from which a trained regression model predicts a future value for a dependent variable;

FIG. 3 is a block diagram that illustrates a computer system upon which an embodiment of the invention may be implemented;

FIG. 4 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Herein is a one-shot, automated, multi-seasonal autoregressive tabular forecaster. In this approach, multiple seasonalities are discovered by autoregression on a timeseries. This approach entails a preprocessor that can generate high quality time-dependent synthetic features. By operations on the timeseries data, this approach can enhance a machine learning regression model to function like an autoregressive model. One innovation is that this approach works in a single shot (i.e. noniterative) and in an automated manner that does not need user input to inform the model about the data domain and its characteristics. This approach learns a tabular-forecasting model that is proficient at capturing multi-seasonal patterns that manifest as autoregressive correlations. Complementing the tabular-forecaster is a novel procedure that, in isolation, models the exogenous timeseries data streams. This helps more accurately predict a future condition of a system of interconnected components, and so helps the tabular-forecaster model predict correlations more accurately.

Herein, timeseries data is stored in a tabular format that can be consumed by a generic regression model that is optimized for tabular data. A timeseries is represented as a two-dimensional table, consisting of rows and columns, by representing each timepoint as a row in the table, along with adding synthetic features generated from historical data to each row. Timeseries often exhibit seasonal patterns with fixed periods, and sometimes multiple overlapping patterns. Feature generation in tabular forecasting should enable the model to learn these features. Synthetic features can include lag features that take the value of a variable at a previous time point and include the past value as a feature for the model at the current time point. Synthetic features may also include rolling statistics such as rolling mean or standard deviation. The state of the art does not preselect temporally-important features that the model requires from the particular data domain and temporal pattern, which decreases model accuracy. Novel one-shot preprocessing informs the tabular-forecasting model, via multiple statistical tests, to extract features that can exactly capture the autoregressive correlations in the timeseries data. This contrasts with generic approaches that evaluate all potential correlations, spending excessive running time and often overfitting to inaccurate autocorrelations. Moreover, preprocessing herein is a general-purpose solution that is robust for learning from all types of data patterns, as opposed to industry solutions which require tailored experimentation or domain expertise to introduce such features.

This approach entails detrending through timeseries decomposition. However, trend detection can be as difficult as the original forecasting problem, and detrending and re-trending a timeseries usually introduces noise into the data that decreases model accuracy. This approach instead entails differencing the timeseries before fitting the model, to handle trend compensation as a separate process. An order (i.e. degree) of differencing determines whether a trend component is accurately captured. If the order is too high, then trend decomposition overfits, which produces exploding forecasts of very large values. If the order is too low, then the trend decomposition becomes ineffective at capturing key trends in the timeseries. Relying solely on statistical measures, this approach automatically: a) identifies when differencing is necessary and b) sets an appropriate degree for it.

Even when future values of exogenous variables are not available, there is still significant value to modelling them, in isolation, to forecast their future values. By learning each exogenous variable in isolation with a distinct respective machine learning model, what is machine-learned may be significantly different from the original model and may capture patterns unique to exogenous regressors.

The novel preprocessor performs automatic predictive feature generation that extracts a set of lag features specific to a timeseries. In an embodiment, the preprocessor uses autocorrelation function (ACF) to adjust the timeseries that the tabular-forecasting model analyzes. Synthetic features herein can capture multiple seasonal and nonseasonal temporal patterns. The novel preprocessor performs automatic timeseries differencing (of an appropriate degree) to mitigate the problem of out-of-bound prediction by the regression-based tabular-forecaster.

This approach entails in-isolation modelling of exogenous variables for when their future values are unknown. This better captures unique patterns of exogenous variables and improves forecast accuracy for the primary variable.

This approach has at least the following advantages. This approach has a first computational acceleration by use of only a few lag features. This approach has a second computational acceleration by reusing (i.e. copying forward) past values instead of emphasizing computationally-intensive rolling statistics. This approach has a third computational acceleration by selectively differencing only when necessary to capture short- and long-term trends in the data.

Predictive feature generation is as follows. This approach automatically generates lags based on an input timeseries, which entails extracting lags based on the autocorrelation function (ACF) of the timeseries. ACF measures a correlation between an original and a lagged timeseries for various lags. When the ACF of a lag i is large and positive, it means that there is a large correlation between time-steps that are i steps apart. This suggests that a timeseries having lag i (in the past) can be predictive of the current time-step. Moreover, on a timeseries with seasonality of period p, the ACF peaks on seasonal lags (p,2p,3p, . . . ). Therefore, the approach herein preselects the lags which are local maxima of the ACF as synthetic features to build the model. For a more accurate analysis of seasonality and to remove the effects of trend, the ACF is applied to the detrended timeseries.

With this approach, models are built tailored to a specific timeseries, and can learn even multiple seasonal patterns, with a minimal count of features and without additional feature engineering. Because machine learning models have many trainable internal parameters and can thus be readily overfit, keeping the feature count low is crucial to avoiding overfitting of the model to an autocorrelation in a timeseries.

Out-of-bound prediction is as follows. While out-of-bound prediction might be needed from forecasting, out of bounds is a problem for machine learning models. For example, an ensemble of tree-based machine learning models, such as with extreme gradient boosting (XGBoost) or light gradient boosting machine (LGBM), cannot make an out of bound prediction. This problem is fixed herein by automatically differencing data prior to fitting the model and performing the inverse of that during prediction.

Isolated forecasting of exogenous regressors to supply missing future or current values is as follows. This enhances the model's ability to exploit all multivariate correlations present in the timeseries. When future values of exogenous variables are unknown, then it is appropriate to forecast them using individual isolated models, as opposed to leveraging the original model itself to exploit autocorrelations in the exogenous variable. One intuition is that when the two univariate timeseries in a multivariate timeseries, even when closely related, exhibit widely different patterns, accuracy is increased by capturing their patterns separately so that each individual model can fit well to the respective patterns in that specific data, as opposed to having a single overparameterized model that tries to capture both patterns at the same time but produces a less accurate outcome.

### 1.0 Example Computer

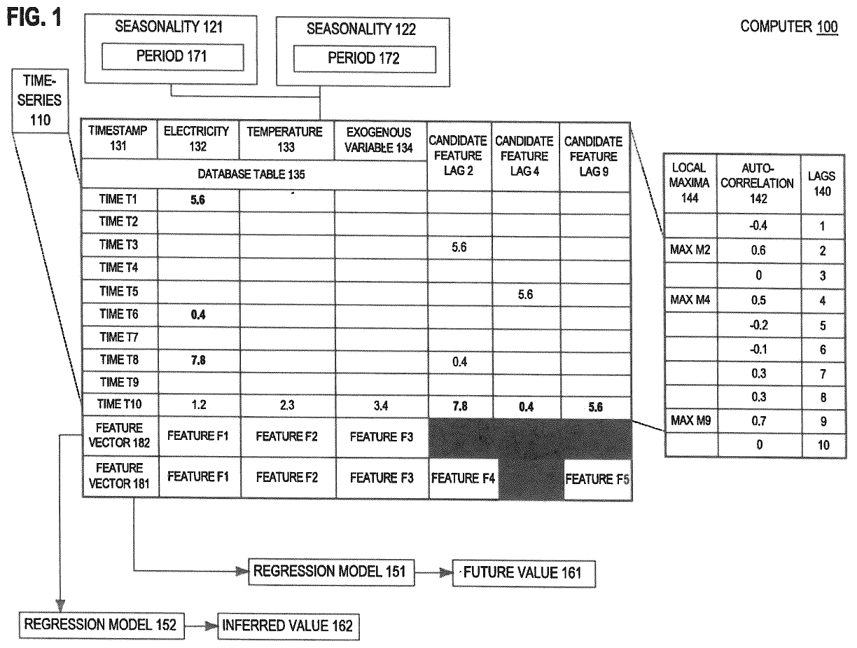

FIG. 1 is a block diagram that depicts an example computer 100 that uses autoregression to discover multiple seasonalities 121-122 in multivariate timeseries 110 from which regression model 151 infers future value 161 for a dependent variable that, in this example, is electricity 132 that is a univariate timeseries consisting of electricity consumption measurements. Computer 100 may be one or more computers (not shown) such as a rack server such as a blade, a personal computer, a mainframe, or a virtual computer. All of the components shown in FIG. 1 may be stored and operated in volatile or nonvolatile storage of computer 100.

Multivariate timeseries 110 consists of a temporally-ordered sequence of multifield records, where each record was generated from observations and measurements at a distinct respective time. Multivariate timeseries 110 consists of multiple shown data fields 131-134 that each is a univariate timeseries consisting of measurements in a distinct respective dimension. For example, data fields 131 and 133 are respective observable dimensions of time and temperature.

### 1.1 Different Respective Roles for Variables

Herein, a data field is also referred to as a variable. Values of variables 132-134 fluctuate over time. In this example, variables 133-134 are exogenous variables that are more or less independent of each other. In that sense, variables 131 and 133-134 are referred to herein as independent variables.

Electricity 132 is referred to herein as the primary variable or the forecasted variable because the purpose of computer 100 is to predict future value 161 for electricity 132. In other words in this example, computer 100 forecasts future electricity demand.

### 1.2 Autoregression on Timeseries Stored in Database Table

In the shown embodiment, each record in timeseries 110 is stored in a distinct respective row in database table 135 that may, for example, be in a relational database. Database table 135 consists of shown columns 131-134. In an embodiment, timestamp 131 is a primary key of database table 135. Blank entries shown in database table 135 and in candidate feature lags 2, 4, and 9 would in practice instead have measurements that are numbers (i.e. numeric values).

Each of seasonalities 121-122 is a distinct cyclic trend that interferes with timeseries 110. Each of seasonalities 121-122 may sometimes increase and sometimes decrease electricity 132. At one time, seasonalities 121-122 may synergistically combine to increase or decrease electricity 132 more than either of seasonalities 121-122 could individually cause. At another time, seasonalities 121-122 more or less cancel each other out without affecting electricity 132. Thus, seasonalities 121-122 may confuse (i.e. decrease the accuracy of) components 151 and 161.

Seasonalities 121-122 have respective distinct periods 171-172 that are natural numbers (i.e. integers) whose dimension is time. Discovery of seasonalities 121-122 may be primarily unsupervised as follows. A prerequisite is that the longest (i.e. largest) period be manually identified or bounded. In this example, period 172 is nine time units that, in this example, is longer than period 171. Thus, a user should manually predefine nine as a maximum period or, in the shown example, manually predefine ten (i.e. shown lags 1-10 in lags 140) as an estimated upper bound of the maximum period.

All seasonalities having a respective period not exceeding the predefined maximum are automatically discovered without supervision as follows. In this approach lags 140 is a one-based sequence of lags 1-10 that are consecutive natural integers. For example, the value of lag 1 is one time unit, and the value of lag 10 is ten time units.

By autoregression on electricity 132 in timeseries 110, a respective value of autocorrelation 142 is measured in timeseries 110 for each one of lags 140. For example as shown, lag 1 has value −0.4 for autocorrelation 142 in timeseries 110. In other words, lag 1 has a negative autocorrelation in timeseries 110. In an embodiment, an autocorrelation function (ACF) measures autocorrelation 142, and each invocation of the ACF accepts a lag as a parameter. In other words, the more distinct lags in lags 140, the more times the ACF is invoked, and each invocation of the ACF analyzes every value in electricity 132 in timeseries 110.

### 1.3 Candidate Feature Lags are Local Maxima Discovered by Autocorrelation

Each value in autocorrelation 142 ranges from −1 to 1. Each value in autocorrelation 142 measures how similar are values of electricity 132 to other values of electricity 132 that are older by a given lag. The more positive is an autocorrelation value for a given lag, the more likely will values repeat in electricity 132 from the given lag. For example, a perfect autocorrelation value of one for a lag of twenty means that a current value of electricity 132 should be identical to the value of electricity 132 from twenty time units ago.

Autocorrelation 142 is a sequence of values that correspond to lags 140. Each value in autocorrelation 142 is adjacent to a previous value and a next value in autocorrelation 142. Any value in autocorrelation 142 that exceeds both of its adjacent values is a local maximum.

For example for lag 2, autocorrelation 142 has value 0.6 that is shown as local maximum M2 in local maxima 144. Local maxima 144 may be a Boolean column. In an embodiment, local maxima 144 is implemented as a set whose members are unique, and only lags 2, 4, and 9 are members of local maxima 144, shown as max M2, M4, and M9. In an embodiment, local maxima 144 is implemented as a bitmap having ten bits for ten lags 1-10, but only bits for lags 2, 4, and 9 are set, shown as max M2, M4, and M9.

For each member M2, M4, and M9 in local maxima 144, a corresponding one of lags 2, 4, and 9 is a distinct candidate feature lag. Lags 1, 3, 5-8, and 10 are not in local maxima 144 and are not candidate feature lags, and this exclusion of most lags provides novel acceleration. In this example, the lagging values of electricity 132 are shown in the row of time T10 as values 7.8, 0.4, and 5.6 for respective candidate feature lags 2, 4, and 9. Candidate feature lags 2, 4, and 9 are not columns in database table 135. In an embodiment, candidate feature lags are generated only for local maxima that have a positive (i.e. above zero) autocorrelation.

### 1.4 Feature Selection Minimizes Count of Feature Lags

Feature selection is performed to select a subset of candidate feature lags, which entails: a) including candidate feature lags that increase the accuracy of components 151 and 161 and b) excluding candidate feature lags that do not increase the accuracy of components 151 and 161. In various embodiments, feature selection entails one, some, or all of: a) accuracy measurement, b) training regression model 151, c) evaluating regression model 151, or d) cross validation of regression model 151.

Local maxima 144 consists of maximums M2, M4, and M9, which is three lags, which is much fewer than lags 140 (i.e. lags 1-10), and fewer lags provides novel acceleration of feature selection as follows. In the shown example, feature selection entails: a) candidate feature lags 2 and 9 are included as respective features F4-5 in feature vector 181, and b) candidate feature lag 4 is excluded from feature vector 181.

In the shown example, the only candidate lag features are maximums M2, M4, and M9. Feature selection detects which of maximums M2, M4, and M9 are significant to (i.e. increase the accuracy of) regression model 151. In the shown example, maximum M4 is excluded by feature selection as insignificant, and maximums M2 and M9 are included by feature selection as features F4-5.

That is, availability of past values of electricity 132 increase inference accuracy of regression model 151, but only at lags of two and nine time units that may, for example, be respective periods 171-172. The row (i.e. record) in database table 135 for time T10 may be understood as follows. Shown values 1.2, 2.3, and 3.4 were recorded at time T10 for respective columns 132-134. Shown values 1.2, 2.3, and 3.4 of columns 132-134 may be stored into feature vector 181 as shown features F1-F3.

Also in feature vector 181 are features F4-5 that do not come from time T10, but instead are copied from earlier (lagged) records as follows. Features F4-5 correspond to candidate feature lags 2 and 9 that have respective values 7.8 and 5.6 that are demonstratively shown bold in the row of time T10. Values 7.8 and 5.6 are shown bold in electricity 132 to demonstrate that values 7.8 and 5.6 are copied into features F4-5 in feature vector 181 from electricity 132 at shown respective times T8 (i.e. lag 2 before time T10) and T1 (i.e. lag 9 before time T10).

Regression models 151-152 infer distinct respective inferred values 161-162 for distinct respective purposes. Regression model 151 predicts future value 151 as a future amount of electricity that will be consumed. That is, regression model 151 predicts a future (e.g. next) value in electricity 132.

### 1.5 Boosted Ensemble of Decision Trees

In an embodiment, regression model 151 does not comprise an artificial neural network (ANN). For example, regression model 151 may instead be a machine learning model that is an ensemble of many decision trees. Gradient boosting is a supervised ensemble training technique where individual weak learners (i.e. machine learning models, e.g. decision trees) in an ensemble are generated (i.e. trained) sequentially one at a time using a labeled training corpus.

The goal of gradient boosting is to create a strong ensemble model by combining the predictions from multiple models. The ensemble is a composite machine learning model that is more accurate than any individual weak learner in the ensemble. Gradient boosting is an iterative approach where, for example, decision trees are built one after another. In the generation sequence of decision trees, training of a next decision tree focuses on more difficult data points in the training corpus that training of the previous decision tree experienced higher training error with.

In an embodiment, the measured training error by a previous decision tree for a data point in a training corpus is used as a nonnegative boosting weight for that data point when training the next decision tree. A training error by a decision tree for a data point is used to adjust the decision tree, which accomplishes learning. With gradient boosting, the training error is increased, immediately before adjusting the tree, by multiplication by the boosting weight of the data point.

In an embodiment, the boosting weight of a data point for training a next decision tree is directly proportional (e.g. identical) to the training error of that data point when the previous decision tree was trained. Thus, each decision tree may be assigned a distinct respective boosting weight for a same data point in the training corpus. In one ensemble embodiment: a) each weak learner is a decision tree, and b) an open source library such as extreme gradient boosting (XGBoost) or light gradient boosting machine (LGBM) performs gradient boosting.

### 1.6 Inferred Value of Exogenous Variable

Regression model 152 infers a missing or future value for temperature 133 that is an exogenous variable. In other words, inferred value 162 is a temperature.

Regression models 151-152 accept respective feature vectors 181-182 as input. Feature vector 182 does not contain lag features (e.g. features F4-5). Thus, regression models 151-152 do not accept a same feature vector.

In one scenario, times T11-12 (not shown) respectively are a current time and a future time, and shown time T10 is a past time. In this scenario, a record of current time T11 has values for columns 132 and 134 but is missing a value for temperature 133. In other words, the record of current time T11 is a partial record. In that case, feature vector 182 may be populated with values from the shown record of past time T10 as input to predict inferred value 162 as an imputed value for a missing value of temperature 133 at current time T11. For example, the shown value of 2.3 for temperature 133 at time T10 may be copied from inferred value 162 to complete the record of current time T11. The completed record of current time T11 may be stored into feature vector 181 as input to predict future value 161 for electricity 132 at future time T12. In other words: a) inferred value 162 is inferred before future value 161 is inferred, and b) inferring future value 161 is based on input that contains inferred value 162.

### 2.0 Example Forecasting Process and Preprocess

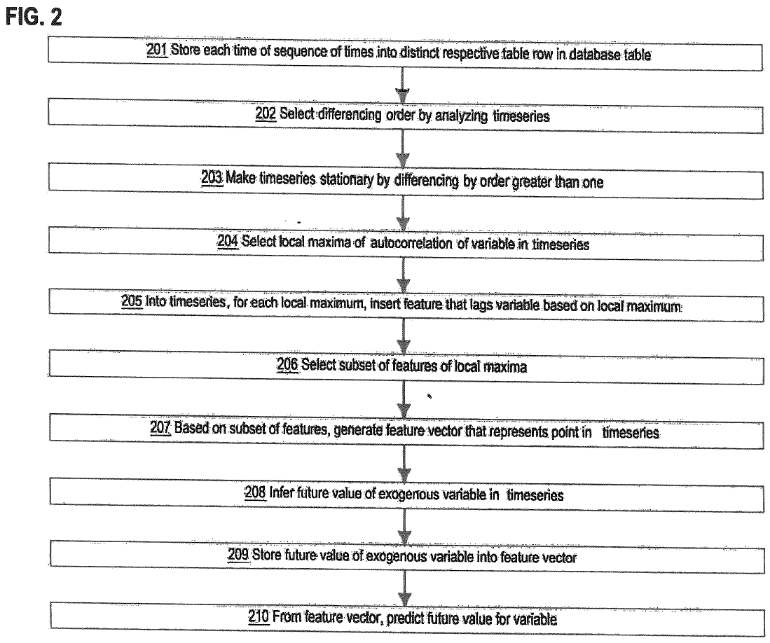

FIG. 2 is a flow diagram that depicts an example process that computer 100 may perform using autoregression to discover multiple seasonalities 121-122 in multivariate timeseries 110 from which regression model 151 infers future value 161 for a dependent variable that, in this example, is electricity 132 that is a univariate timeseries consisting of electricity consumption measurements. The process of FIG. 2 may consist of a development phase followed by a runtime phase.

The development phase may, for example, occur in a laboratory environment and may consist of a sequence of stages that are a preparatory stage including step 201, a preprocessing stage in which steps 202-203 perform detrending, and a lag feature selection stage including steps 204-206. Preparatory step 201 stores each timestamped record of timeseries 110 into a distinct respective table row in database table 135. For example, data structures 110 and 135 may contain more times and records in addition to shown times T1-10.

Stationarity of timeseries 110 is achieved with detrending by steps 202-203 as follows. Stationarity and detrending increase the accuracy of components 151 and 161. Step 202 selects a differencing order by analyzing timeseries 110.

A differencing order is a count (i.e. whole number, nonnegative integer) of how many individual differencings does timeseries 110 need to be sufficiently differentiated to become trend-stationary (i.e. trendless). A trend in timeseries 110 may decrease accuracy of components 151 and 161 and may decrease the likelihood of discovering seasonalities 171-172.

In this example, step 203 makes timeseries 110 stationary by differencing by an order greater than one. In other examples, the differencing order is zero or one. In an embodiment, step 203 uses the unit root test of Augmented Dickey-Fuller (ADF) to calculate what whole number should be the differencing order as follows.

The ADF test is a statistical procedure that detects whether a timeseries has a unit root, which is a binary (i.e. yes/no) detection. In reaction to a shock or change in the timeseries, a unit root would cause an immediate and long-lasting shift in future values in the timeseries. Thus, a unit root in timeseries 110 may confuse (i.e. decrease accuracy of) regression model 151.

The ADF test assesses stationarity of timeseries 110. A stationary variable has a constant mean, variance, and autocorrelation. The ADF test essentially tests a null hypothesis that there is a unit root in timeseries 110 against an alternative hypothesis that timeseries 110 is stationary (or trend-stationary depending on the specific test version). In other words, stationarity and a unit root are mutually exclusive. That is, timeseries 110 has either stationarity or a unit root but not both.

The ADF test measures a specific statistic that is a negative number. The more negative the value, the less likely is a unit root in timeseries 110. An embodiment may have an ADF threshold that is a negative number that has a magnitude (i.e. absolute value) that indicates a unit root (i.e. no stationarity) when the threshold magnitude is exceeded by the magnitude of the ADF statistic. Herein, the threshold magnitude may be referred to as a critical value.

Step 204 selects local maxima 144 (i.e. maxima M2, M4, and M9) of autocorrelation 142 of electricity 132 in timeseries 110 as discussed earlier herein. Local maxima 144 has much fewer members than lags 140 (i.e. lags 1-10), and fewer members provides novel acceleration as discussed later herein. Into timeseries 110, for each of local maxima 144, step 205 creates a respective distinct candidate feature lag that lags electricity 132 based on a respective local maximum.

Herein, a candidate feature lag is a synthetic feature that may be included or excluded by feature selection. In the example shown in FIG. 1, step 205 creates candidate feature lags 2, 4, and 9 respectively for maxima M2, M4, and M9. The datatype and numeric units of candidate feature lags 2, 4, and 9 are the same as electricity 132.

In an embodiment, all values in candidate feature lags 2, 4, and 9 are copied from electricity 132. For example, the row at time T10 shows values 7.8, 0.4, and 5.6 for respective candidate feature lags 2, 4, and 9, and those values are copied from other times (i.e. other rows) in electricity 132. For example, value 5.6 in candidate feature lag 9 at time T10 is copied from time T1 (i.e. T10−lag 9=T1) in electricity 132. Likewise, value 0.4 in candidate feature lag 4 at time T10 is copied from time T6 (i.e. T10−lag 4=T6) in electricity 132.

Because there are three candidate feature lags 2, 4, and 9, their values are copied, for time T10, from three respective distinct other (i.e. not time T10) times T8, T6, and T1 in electricity 132 as shown. A value of electricity 132 of a particular earlier time may be copied into a respective distinct other row/time for each of candidate feature lags 2, 4, and 9. For example as shown in FIG. 1, same value 5.6 at time T1 in electricity 132 is reused (i.e. copied) into respective candidate feature lags 2, 4, and 9 in shown respective rows of times T3, T5, and T10.

By feature selection discussed earlier herein, step 206 selects multiple included feature lags 2 and 9 as an included subset of candidate feature lags. Step 206 excludes candidate feature lag 4.

Based on the included subset of feature lags, step 207 generates feature vector 181 that represents time T10 that is a data point in timeseries 110. Feature vector 181 contains: a) features F1-3 whose values are copied from, for example, time T10 and b) features F4-5 whose values are copied from respective included feature lags 2 and 9. Because candidate feature lag 4 was deselected, feature vector 181 does not contain a value of candidate feature lag 4.

In one scenario that entails steps 208-210, time T10 is a current time, but temperature 133 is missing for T10. In that case, feature vector 182 may be populated with values from the record of past time T9 as input to infer, by regression model 152 in step 208, inferred value 162 as an imputed value for the missing value of temperature 133 at current time T11. For example in FIG. 1, the shown value of 2.3 for temperature 133 at time T10 may have been copied from inferred value 162 to complete the record of current time T10. In step 209, the completed record of current time T10 is stored into feature vector 181 as input to predict, by regression model 151 in step 210, future value 161 for electricity 132 at future time T11 (not shown). In other words: a) inferred value 162 is inferred before future value 161 is inferred, and b) inferring future value 161 is based on input that contains inferred value 162.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

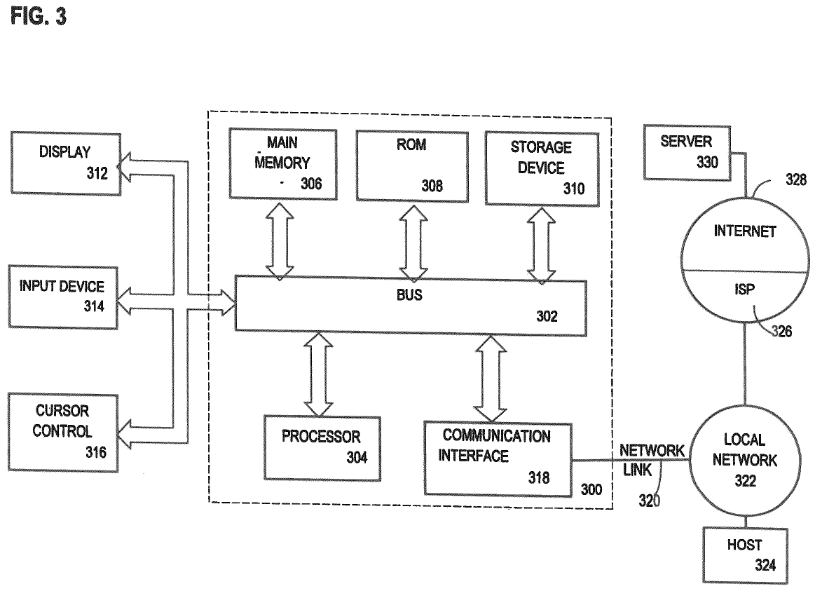

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### Software Overview

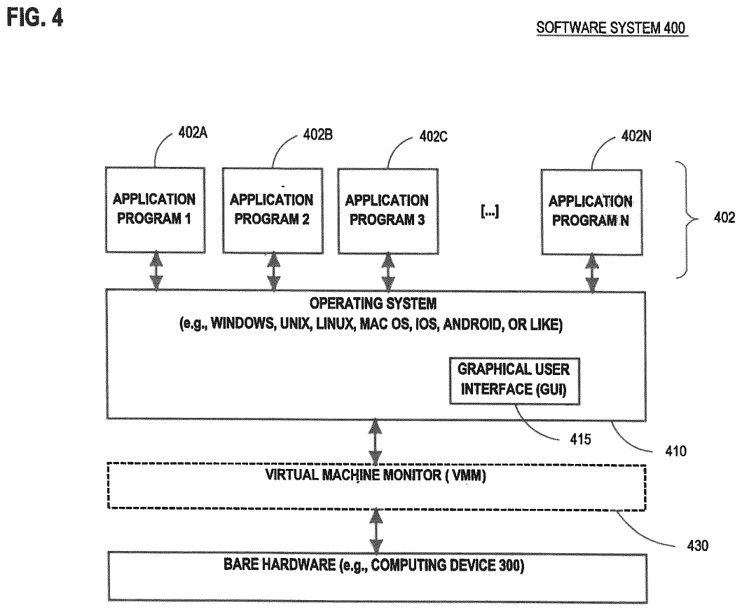

FIG. 4 is a block diagram of a basic software system 400 that may be employed for controlling the operation of computing system 300. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computing system 300. Software system 400, which may be stored in system memory (RAM) 306 and on fixed storage (e.g., hard disk or flash memory) 310, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 310 into memory 306) for execution by the system 400. The applications or other software intended for use on computer system 300 may also be stored as a set of downloadable computer-executable instructions, for example, for downloading and installation from an Internet location (e.g., a Web server, an app store, or other online service).

Software system 400 includes a graphical user interface (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 304) of computer system 300. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 300.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 300 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
selecting a plurality of local maxima of an autocorrelation of a variable in a timeseries, wherein the variable has a first seasonality that has a first period and a second seasonality that has a second period that is longer than the first period;
inserting, into the timeseries, for each local maximum of the plurality of local maxima, a feature that lags the variable based on the local maximum;
selecting a subset of said features of the plurality of local maxima;
generating, based on the subset of said features of the plurality of local maxima, a feature vector that represents a point in the timeseries; and
predicting, from the feature vector, a future value for the variable.

2. The method of claim 1 further comprising making the timeseries stationary by differencing by an order greater than one.

3. The method of claim 2 further comprising selecting said order by analyzing the timeseries.

4. The method of claim 2 wherein said making the timeseries stationary occurs before said selecting the plurality of local maxima.

5. The method of claim 1 wherein:
the method further comprises inferring a future value of an exogenous variable in the timeseries;
said generating the feature vector comprises storing the future value of the exogenous variable into the feature vector.

6. The method of claim 5 wherein separate respective machine learning models perform said predicting and said inferring.

7. The method of claim 1 wherein said selecting the plurality of local maxima is based on the second period that is longer than the first period.

8. The method of claim 1 wherein:
the timeseries contains a sequence of times;
the method further comprises storing each time of the sequence of times into a distinct respective table row in a database table.

9. The method of claim 1 wherein the plurality of local maxima consists only of local maxima that are positive.

10. The method of claim 1 wherein said predicting is not performed by an artificial neural network.

11. One or more non-transitory computer-readable media storing instructions that, when executed by one or more processors, cause:
selecting a plurality of local maxima of an autocorrelation of a variable in a timeseries, wherein the variable has a first seasonality that has a first period and a second seasonality that has a second period that is longer than the first period;
inserting, into the timeseries, for each local maximum of the plurality of local maxima, a feature that lags the variable based on the local maximum;
selecting a subset of said features of the plurality of local maxima;
generating, based on the subset of said features of the plurality of local maxima, a feature vector that represents a point in the timeseries; and
predicting, from the feature vector, a future value for the variable.

12. The one or more non-transitory computer-readable media of claim 11 wherein the instructions further cause making the timeseries stationary by differencing by an order greater than one.

13. The one or more non-transitory computer-readable media of claim 12 wherein the instructions further cause selecting said order by analyzing the timeseries.

14. The one or more non-transitory computer-readable media of claim 12 wherein said making the timeseries stationary occurs before said selecting the plurality of local maxima.

15. The one or more non-transitory computer-readable media of claim 11 wherein:
the instructions further cause inferring a future value of an exogenous variable in the timeseries;
said generating the feature vector comprises storing the future value of the exogenous variable into the feature vector.

16. The one or more non-transitory computer-readable media of claim 15 wherein separate respective machine learning models perform said predicting and said inferring.

17. The one or more non-transitory computer-readable media of claim 11 wherein said selecting the plurality of local maxima is based on the second period that is longer than the first period.

18. The one or more non-transitory computer-readable media of claim 11 wherein:
the timeseries contains a sequence of times;
the instructions further cause storing each time of the sequence of times into a distinct respective table row in a database table.

19. The one or more non-transitory computer-readable media of claim 11 wherein the plurality of local maxima consists only of local maxima that are positive.

20. The one or more non-transitory computer-readable media of claim 11 wherein said predicting is not performed by an artificial neural network.
